(19) United States
(12) Patent Application Publication
(10) Pub. No.: US 2009/0033141 A1
(43) Pub. Date: Feb. 5, 2009

(54) POWERED MOTOR VEHICLE REAR AXLE OF A TWIST-BEAM AXLE TYPE

(75) Inventors: Gerd BITZ, Mainz (DE); Dirk EHRLICH, Bodenheim (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/184,959

(22) Filed: Aug. 1, 2008

(30) Foreign Application Priority Data
Aug. 1, 2007 (DE) 102007036080.2

(51) Int. Cl. B60B 35/00

(52) U.S. Cl. 301/124.1

(57) ABSTRACT

A powered motor vehicle rear axle is provided can be coupled with a motor vehicle drive train. The rear axle is configured as twist-beam rear axle with two wheel carrying resistant trailing arms that are elastically linked to the motor vehicle structure and a bending resistant, but torsion flexible cross member. Here each trailing arm swings around at least one swivel axle. In the area of its both ends the cross member is welded to the trailing arms 12. The cross member is bent upwards to make space for the installation of at least one module allocated for the drive train, for example for the installation of a drive shaft and a rear axle differential. The cross member at least in the middle thereof is provided with an open profile that includes, but is not limited to a first profile leg and a second profile leg. The profile at least predominantly opens into a half-space situated above a plane spanned at an apex region of the first and second profile legs and being in parallel alignment with both vehicle's longitudinal and transverse axles.

### CROSS-REFERENCE TO RELATED APPLICATION

This application claims priority to German Patent Application No. 102007036080.2, filed Aug. 1, 2007, which is incorporated herein by reference in its entirety.

### TECHNICAL FIELD

The technical field relates to a powered motor vehicle rear axle, which can be coupled with a motor vehicle drive train. It also concerns a motor vehicle with such a powered motor vehicle rear axle.

### BACKGROUND

The powered motor vehicle rear axles are already known to have a large number of sheets resulting in relatively high expenditure in installation and welding. Additionally, the endurance limit of welded sheets is critical. Axles with an edged torsion profile have already been suggested, whereby the edged torsion profile has not only been used with four-wheel vehicles, but also with vehicles without four-wheel drive. However, all these axles consist of a large number of sheets which again leads to the aforementioned disadvantages.

In view of foregoing, at least one task is to create an improved powered motor vehicle rear axle as well as an improved motor vehicle of the aforementioned type, which allow a particularly cheap rear axle construction. In addition, other tasks, desirable features and characteristics will become apparent from the subsequent summary and detailed description and the appended claims, taken in conjunction with the accompanying drawings and this background.

### SUMMARY

The at least one task, other tasks, desirable features, and characteristics are provided in accordance with an embodiment. This embodiment of a powered motor vehicle rear axle, which can be coupled with the motor vehicle drive train and is designed as twist-beam rear axle with two wheel carrying rigid trailing arms that are elastically linked at the motor vehicle structure and a bending resistant but torsion flexible cross member. Here each of the trailing arms swings at least around one swivel axle. The cross member comprises an open in particular double-walled profile at least in a middle region thereof. The cross member is located in front of the wheel centers (viewed lengthwise from of the motor vehicle) and distanced from the swivel axles. Moreover, in the area of its two ends the cross member is welded to the trailing arms. To make space for the installation of at least one module allocated for the drive train the cross member is bent upwards.

The embodiment is characterized in that the cross member is provided with an open profile at least in a middle region thereof that is provided with a first profile leg and a second profile leg that are connected at an apex region of the profile. Here the profile opens at least predominantly into a half-space located above a plane that is spanned at the apex region in parallel alignment with both the motor vehicle's longitudinal axis (roll axis) and transverse axis.

The outcome of this solution is a particularly cheap powered motor vehicle rear axle, whereby due to the cross member bent upwards space is created for the installation of the module allocated for the drive train. Here the cross member can, in particular, be bent in such a way that sufficient space is created to install a drive shaft and a rear axle differential. By means of the upwards bent cross member an upwards shift of a shear centre (and roll center) of the rear axle is effected. Due to the cross member's profile at least predominantly opening into the upper half-space, a downwards shift of the shear centre (and roll centre) can advantageously be achieved in order to counteract the upwards shift of the shear centre that results from the upwards bent cross member.

In other words, the powered motor vehicle rear axle according to the embodiment is a twist-beam rear axle where the cross member, which is welded with the trailing arms, sits, in contrast to common rigid axles, in front of the wheel center and takes up all high and lateral moments of a torque and thus simultaneously acts as a stabilizer.

According to a preferred embodiment, in the middle of the cross member in a section along a plane in vertical arrangement with the extending direction of the cross member (i.e. motor vehicle middle plane), the open profile of the cross member is formed symmetrically with regard to a symmetry line. Here, the symmetry line of the profile, starting from the apex region of the two profile legs, extends in the upper half-space of the plane that is arranged at the apex region of the two profile legs and, additionally, is angled at an angle of more than about 0° with respect to that plane. It is particularly preferred if the symmetry line is angled at an angle in a range of more than about 0° to about 40° at a maximum with respect to that plane. It is even more preferred if the symmetry line is angled at an angle in a range of about 30° to about 40° with respect to that plane, and, it is yet even more preferred if the symmetry line is angled at an angle of about 40° with respect to that plane.

Upon doing so, it advantageously can be achieved that water collecting in the open profile during operation of the motor vehicle can run off the profile which otherwise might cause problems by freezing in cold weather.

According to yet another preferred embodiment, the cross member may be provided with an open profile which at least predominantly opens into a half-space located at the vehicle's front-side of a plane that is spanned at the apex region of the two profile legs and, additionally, is in parallel alignment with the motor vehicle's vertical axis and transverse axis.

Alternatively, according to yet another preferred embodiment, the cross member may be provided with an open profile which at least predominantly opens into a half-space located at the vehicle's tail-side of a plane that is spanned at the apex region of the two profile legs and, additionally, is in parallel alignment with the motor vehicle's vertical axis and transverse axis.

Preferably, the cross member is bend upwards at least in its middle region (viewed lengthwise from of the brace) according to a prescribed amount.

According to a preferred practical embodiment of the powered motor vehicle rear axle the cross member possesses at each of its two ends a relatively torsion resistant cross section and in the middle region a relatively torsion flexible U-, V-, or similar cross section with double or single wall profile legs.

Here the crossover region between the torsion resistant and the torsion flexible cross section is preferably designed in a smooth way.

It is particularly advantageous if the cross section of the junction between the respective trailing arm and the cross member has a symmetrical rotation form which allows an axial turning of the cross member prior to the welding of the connection.

Due to this symmetrical rotation form and independent on the form of the cross section of the cross member in the torsion area the cross member can be turned as desired prior to the welding to the trailing arms. The length of the shear center in the torsion area can thus be changed as desired even during the serial production.

With reduced production efforts it is possible to guarantee various requirements in terms of the characteristics to be fulfilled, particularly the change of the hitch and toe-in with reciprocal deflection and/or the resonant steering behavior of the rear axle when cornering. Then it is also possible to achieve higher durability and load capacity.

According to a preferred embodiment the trailing arms are designed as bending and torsion resistant cast parts. This allows integrating all necessary parts such as the wheel mount plate, spring seat, the eye to attach the shock absorber and, possibly, a stabilizer, a holder for the lying or standing damping bushes and other chassis parts into the trailing arm.

To increase the stability and/or to reduce the weight the trailing arms can also be cast from steel or light alloy.

To connect the cross member with the trailing arms they must be connected with the respective end of the cross member. Thus the trailing arms are provided with an attachment piece whose cross section can preferably be round or oval.

A particularly advantageous design occurs if the attachment piece is designed as a tube and its wall thickness at the junction with the cross member equals the wall thickness of the respective end of the cross member. This type of design of the attachment piece is particularly suitable for welding procedures according to the Magnet-Arc welding technique. The required wall thickness (wall thickness of pipe profile end and attachment piece should be the same) can be changed to a wall thickness which is suitable for the welding either by mechanically re-working the attachment piece or by deforming the pipe profile end, i.e. the end of the cross member.

As an alternative the outer perimeter and/or diameter of the attachment piece can be similar or somewhat smaller than the inner perimeter and/or diameter of the cross member built by a pipe profile. For a connection with the trailing arm the profile pipe end can simply be put onto the attachment piece and, thus, exactly be positioned before it is welded to the attachment piece at its front face.

According to an additional alternative embodiment it is possible to connect each trailing arm with the respective end of the cross member built by a pipe profile. Here it can be put into an opening in the respective attachment piece and welded to the front face of the attachment piece.

The load capacity of the powered motor vehicle rear axle of the twist-beam rear axle system according to an embodiment can be increased quite easily by using a more resistant cross member with a larger cross section area and/or form in the torsion region. Such a cross member can be manufactured according to already known procedures such as the internal high pressure deformation technique. Here only the diameter of the raw material is extended in the torsion region before it is deformed into a U-, V- or similar cross section. Thus, it is possible to particularly influence the steadiness and the torsion rate of the pipe profile without changing the junction to the trailing arms.

To distribute occurring forces and torsion stresses equally in the pipe profile the crossover regions between the torsion resistant and torsion flexible cross section are ideally formed in a way that the torsional resisting torque decreases continuously from the torsion resistant to the torsion flexible cross section. Because the torsional resisting torque depends on the cross section surface and geometry, it is possible to achieve such a course of the torsion resisting torque by means of a continuous deformation of the pipe profile with a defined change of the cross section.

The production of the pipe profile according to an embodiment is relatively easy and cheap since a common pipe can be used as raw material. Prior to the deformation it is possible to insert special molded parts into this pipe for the torsion region and the crossover regions, in order to reach the desired cross section of the profile. Subsequently, the pipe can mechanically be formed into the prescribed cross section with an appropriate stamp. After the removal of the molded parts, the pipe can be welded with the trailing arms in a welding fixture.

The trailing arms can, for example, swing around an axle which is at least (mainly) vertical in relation to the longitudinal direction of the motor vehicle (i.e., in particular a vertical transverse axle).

Thus, a cheap powered motor vehicle rear axle of a twist-beam rear axle type with a cross member that consists of a one-piece pipe profile is specified. This cross member is generally bent upwards to make space for the installation of at least on module allocated for the drive train, such as for the installation of a drive shaft and a rear axle differential. While the torsion profile is made of one single pipe, the trailing arms can be designed as cast link. The torsion profile and/or the cross member can have a round, closed cross section particularly at the edge. In the middle section the pipe can, for example, be deformed to a U-form. Due to package reasons, the torsion profile in the middle section is bent upwards according to a prescribed amount. To link the trailing arms even or inclined bearing bushes can be used. If possible, the body roll center can be hoisted. With different pipe strengths and cross sections, the axle can easily be adjusted to various requirements (e.g., motor vehicle weight, base/sport/OPC suspension, etc.) without having to change the expensive trailing arms.

### BRIEF DESCRIPTION OF THE DRAWINGS

The present invention will hereinafter be described in conjunction with the following drawing figures, wherein like numerals denote like elements, and

FIG. 1 is a schematic perspective view of a first exemplary embodiment of a powered motor vehicle rear axle;

FIG. 2 is a schematic sectional view as vertically sectioned through the middle of the cross member of the rear axle of FIG. 1; and

FIG. 3 is a schematic sectional view as vertically sectioned through the middle of the cross member of a second exemplary embodiment of a powered motor vehicle rear axle.

### DETAILED DESCRIPTION

The following detailed description is merely exemplary in nature and is not intended to limit application and uses. Furthermore, there is no intention to be bound by any theory presented in the preceding summary and background or the following detailed description.

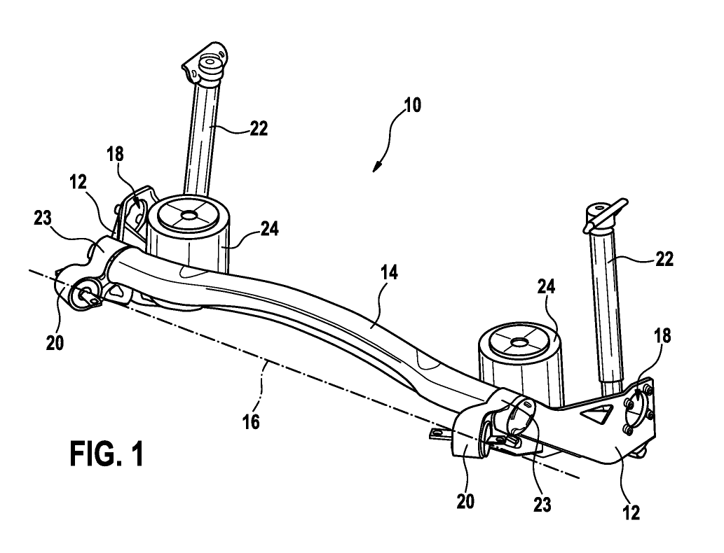

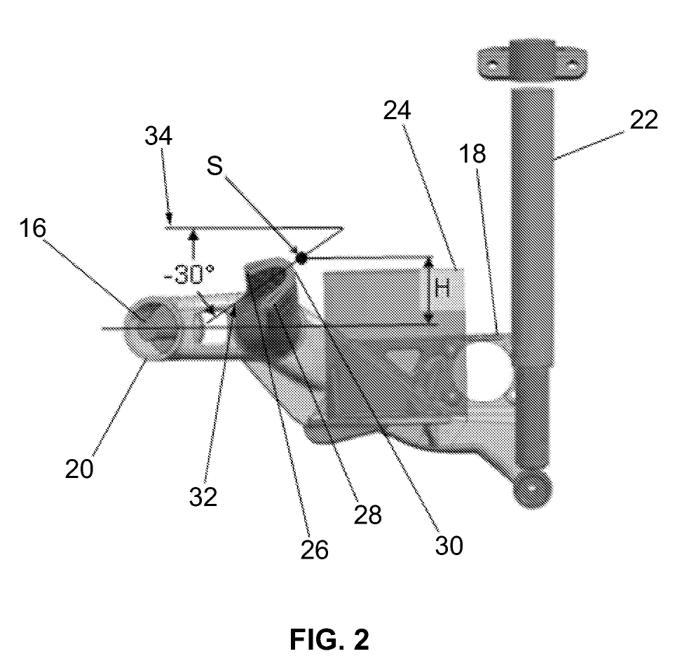

In FIG. 1 and FIG. 2, a first exemplary embodiment of the motor vehicle rear axle 10 according to an embodiment is shown. Because it is powered, it can be coupled with the motor vehicle drive train. As it can be seen from the only figure, the powered motor vehicle rear axle 10 is designed as a twist-beam rear axle with two wheel carrying resistant trailing arms 12 which are elastically linked to the motor vehicle structure and a bending resistant but torsion flexible cross member 14.

Here, each trailing arm 12 swings around at least one swivel axle 16. The cross member 14 is provided with an open profile in its middle region that changes into a closed profile at the end regions thereof. It is separate from the swivel axles 16 and is configured in front of the wheel center when viewed lengthwise from of the motor vehicle.

In the region of its both ends, the cross member 14 is welded to the trailing arms 12.

As it can be seen by means of FIG. 1, the cross member 14 is bent upwards to make space for the installation of at least one module allocated for the drive train, for example for the installation of a drive shaft and a rear axle differential. Here, the cross member 14 is at least in its middle section, when viewed lengthwise from of the rod, bent upwards by a prescribed amount.

In its both ends the each cross member 14 possesses a relatively torsion resistant cross section and in the middle section a relatively torsion flexible U- and V-cross section, respectively, with two double-walled profile legs. In the middle section this cross member 14 is thus significantly more torsion flexible than in the section of its both ends which have a relatively more torsion resistant cross section.

The crossover region between the torsion resistant and the torsion cross section is smoothly formed.

At the rear end of the trailing arm 12 retainers 18 are provided for the connection with, in each case, one wheel carrier for bearing one wheel. At its front end each trailing arm 12 is elastically linked via a joint 20 at the motor vehicle structure which is not depicted. Here the joints define the swivel axles 16 around which the trailing arms 12 swing.

With the execution example presented here the cross section of the junction has, between the respective trailing arm 12 and the cross member, a symmetrical rotation form which allows an axial turning of the cross member 14 prior to the welding of the connection.

In particular, the trailing arms 12 can be configured as bending and torsion resistant cast parts.

For the connection with the respective ends of the cross member 14 the trailing arms 12 can be provided with an attachment piece 23 whose cross section can preferably be round or oval. Here, the respective attachment piece 23 can have a tubular design and, at the junction with the cross member 14, it can have a wall strength which is about the same as the wall strength of the relevant end of the cross member 14. Particularly in this case, the trailing arms 12 and/or their attachment pieces 23 can be connected with the ends of the cross member 14 according to the Magnet-Arc welding technique.

Additionally, a design is imaginable in which the respective end of the cross member 14 is put onto the respective attachment piece 23 and is welded to the attachment piece 23 at the front face of the cross member 14 to connect the relevant trailing arm 12.

For the connection with each trailing arm 12, it is also possible to put the respective end of the cross member 14 into an opening in the respective attachment piece 23 and to connect it at the front faces of the attachment piece 23.

It is also possible to extend the wall strength of the cross member 14 at its two ends in relation to the wall strength in the torsion region (by deforming).

In principle, a design is imaginable where, prior to the deforming into a U-, V- or similar cross section, the cross member 14 possesses a lower diameter than it has at its two ends in the torsion region.

Additionally, the cross member 14 can be deformed at the crossover regions between the torsion resistant and the torsion flexible cross section in such a way that the torsional resisting torque between the torsion resistant and the torsion flexible cross section progressively decreases.

The only figure shows also the shock absorber 22 and the springs 24.

As can be seen from FIG. 2, which is a vertical sectional view as sectioned through the middle of the cross member 14 along a plane in vertical arrangement with the extending direction of the cross member 14, the cross member 14 is provided with an open profile being at least approximately formed in U- and V-cross section, respectively. The open profile has a first profile leg 26 and a second profile leg 28 that are commonly connected at an apex region 30. Here, the profile is symmetrically formed with regard to symmetry line 32. The profile's opening that is formed by the two profile legs 26, 28 and arranged in opposite relationship to the apex region 30 is directed into a lower half-space located beneath a plane spanned at the apex region 30. Here, this plane is arranged in parallel relationship to both the motor vehicle's longitudinal axis and transverse axis and, thus, generally relates to a horizontal plane in case the motor vehicle is on a horizontal roadway. More exactly, the symmetry line 32 in between the two profile legs 26, 28 is situated in the lower half-space of the plane and is angled at an angle of about −30° with respect to that plane.

A shear centre S of the rear axle that is shifted upwards by means of the upwards bent cross member is again shifted upwards by the cross member's 14 profile. FIG. 1 illustrates the shear centre S of the rear axle 10 that is positioned in extension of the symmetry line 32. In FIG. 1, a vertical distance of the shear centre S from a horizontal line extending through the swivel axle 16 is given as H which in this example amounts to about 9 cm. In the exemplary embodiment of FIG. 1, such vertical distance H results in a roll-understeering of about 21%, i.e. during cornering a wheel linked to the rear axle that is situated on the outer side of the curve is brought in relatively large toe-in which, however, in general is considered undesired since the vehicle has a slower steering-behavior in that case.

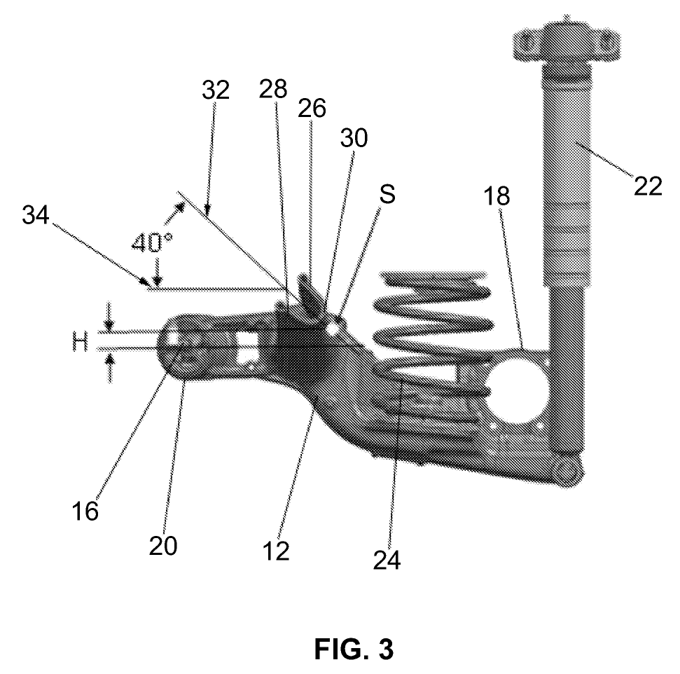

Contrary thereto, FIG. 3 shows another exemplary embodiment of the rear axle 10 of an embodiment which eliminates above disadvantage. In order to avoid unnecessary repetitions only the differences between both exemplary embodiments are explained and, otherwise, reference is made to above explanations made in connection with FIG. 1 and FIG. 2. Similar or similarly acting members are signed with same reference numerals.

The rear axle 10 shown in FIG. 3 differs from that one shown in FIG. 1 and FIG. 2 in that the profile of the cross member 14 opens into the upper half-space of the plane spanned at the apex region 30. More exactly, the symmetry line 32 in between both profile legs 26, 28, starting from the apex region 30, extends into the upper half-space of the plane and is angled at an angle of about 40° with respect to that plane.

A shear centre S (and also the roll centre) of the rear axle 10 which is shifted upwards by the upwards bent cross member 14 is shifted downwards by the cross member's open profile as can bee seen in FIG. 3 showing the shear centre S to be located in extension of the symmetry line 32. Here, a vertical distance H of the shear centre S from a horizontal line extending through the swivel axle 16 is reduced compared to the vertical distance H of the rear axle 10 of FIG. 1 and FIG. 2 and amounts to about 3 cm in that case. Such reduced vertical distance H results in a reduced roll-understeering of about 10% (i.e., during cornering a wheel linked to that rear axle that is situated on the outer side of the curve is brought in relatively small toe-in so that the vehicle shows better steering-behavior without a risk of over-steering). While the profile is opening towards the upper side of the vehicle in order to reach a downwards shift of the shear centre S, water collecting in the open profile may sufficiently run-off to the sides thereof so that a satisfying trade-off as to downward shift of the shear centre S and run-off of water can be achieved.

The open profile of the cross member 14 in the middle of the cross member 14 also opens into a half-space situated on the vehicle's front-side of a plane spanned at the apex region 30 of both profile legs 26, 28. Here, the plane is in parallel alignment with both the vehicle's vertical axis and transverse axis. Upon doing so, advantageous cinematic properties of the rear axle 10 can be achieved.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A powered rear axle for motor vehicle having a motor vehicle structure and configured for coupling to a motor vehicle power train, comprising:
a twisted beam axle with at least two stiff trailing arms elastically mounted to the motor vehicle structure
at least two wheels supported by the twisted beam axle; and
a stiff and torsion-soft cross member interposed between the at least two stiff trailing arms,
wherein the cross member comprises a middle region with at least an open profile bent upwards to provide a space for incorporation of at least one module allocated for the motor vehicle power train,
wherein at least the middle region of the cross member comprising a first profile leg and a second profile leg and the open profile at least predominantly opens into a half-space situated above a plane spanned at an apex region of the first profile leg and second profile leg and substantially aligned in parallel alignment with a longitudinal axis and traverse axis of the motor vehicle.

2. The powered rear axle according to claim 1, wherein the open profile of the cross member in a section along a plane in vertical arrangement with an extending direction of the cross member is symmetrically formed with respect to a symmetry line,
wherein the symmetry line, starting from the apex region, extends in the upper half-space of the plane spanned in the apex region of the first profile leg and second profile leg, has an angle greater than about 0° with respect to the plane.

3. The powered rear axle according to claim 2, wherein the angle has a range of about 0° to about 40°.

4. The powered rear axle according to claim 3, wherein the angle has a range of about 30° to about 40°.

5. The powered rear axle according to claim 4, wherein the angle is about 40°.

6. The powered rear axle according to claim 1, wherein the open profile opens into a half-space situated on a front-side of the motor vehicle of a plane spanned at the apex region of the first profile leg and second profile leg and aligned substantially parallel with a longitudinal and vertical axis of the motor vehicle.

7. The powered rear axle according to claims 1, the open profile opens into a half-space situated on a tail-side of the motor vehicle of a plane spanned at the apex region of the first profile leg and second profile leg and aligned substantially parallel with a longitudinal axis and vertical axis of the motor vehicle.

8. The powered rear axle according to claim 1, wherein the cross member comprises a first end and a second end and the first end and second end has a relatively torsion-stiff cross-section and the middle region has a relatively torsion-soft U-cross-sections.

9. The powered rear axle according to claim 1, wherein the cross member comprises a first end and a second end and the first end and second end has a relatively torsion-stiff cross-section and the middle region has a relatively torsion-soft V-cross-sections.

10. The powered rear axle according to claim 8, wherein the relatively torsion-soft U-cross-section has double walled profile legs.

11. The powered rear axle according to claim 8, wherein a crossover region from the torsion-stiff section to the torsion-soft section is substantially smooth.

12. The powered rear axle according to claim 1, wherein the cross-section of a connecting location between one of the trailing arms and the cross member has a symmetrical rotation form that allows an axial turning of the cross member before the welding of a connection.

13. The powered rear axle according to claim 1, wherein the trailing arms are configured as stiff and torsion-stiff cast components.

14. The powered rear axle according to claim 1, wherein the trailing arms are provided with an attachment to connect the ends of the cross member.

15. The powered rear axle according to claim 1, wherein the cross member has a diameter in a torsion region having a first end and a second end.

16. The powered rear axle according to claim 1, wherein the cross member is transformed in such a way at its crossover from the torsion-stiff to the torsion-soft cross-sections, that a torsion resistance momentum from the torsion-stiff to the torsion-soft cross-section is progressively lessened.
